(19) United States
(12) Patent Application Publication
(10) Pub. No.: US 2012/0229848 A1
(43) Pub. Date: Sep. 13, 2012

(54) DISTRIBUTION APPARATUS, DISTRIBUTION METHOD, AND RECORDING MEDIUM

(75) Inventor: Megumi SAWAMURA, Kanagawa (JP)

(73) Assignee: RICOH COMPANY, LTD., Tokyo (JP)

(21) Appl. No.: 13/406,585

(22) Filed: Feb. 28, 2012

(30) Foreign Application Priority Data
Mar. 10, 2011 (JP) 2011-052358

(51) Int. Cl. G06F 15/00

(52) U.S. Cl. 358/1.15

(57) ABSTRACT

A distribution apparatus includes a determining part configured to determine whether a specified format in correspondence information matches the format of an input original material, the specified format being correlated with a corresponding distribution destination apparatus in the correspondence information; and a distributing part configured to distribute the input original material to the distribution destination apparatus correlated with the specified format in response to the determining part determining that the specified format in the correspondence information matches the format of the input original material.

### CROSS-REFERENCE TO RELATED APPLICATION

The present application is based upon and claims the benefit of priority of Japanese Patent Application No. 2011-052358, filed on Mar. 10, 2011, the entire contents of which are incorporated herein by reference.

### BACKGROUND OF THE INVENTION

1. Field of the Invention

The present invention relates to a distribution apparatus and a distribution method that distribute an input original material to distribution destination apparatuses, and to a recording medium having a program recorded thereon, wherein the program instructs a computer processor to execute the distribution method.

2. Description of the Related Art

Conventionally, distribution systems have been proposed that distribute an original material input by a user to network-connected apparatuses based on the user's operation command. (See, for example, Japanese Laid-Open Patent Application No. 2009-146244.)

### SUMMARY OF THE INVENTION

According to an aspect of the present invention, a distribution apparatus includes a determining part configured to determine whether a specified format in correspondence information matches a format of an input original material, the specified format being correlated with a corresponding distribution destination apparatus in the correspondence information; and a distributing part configured to distribute the input original material to the distribution destination apparatus correlated with the specified format in response to the determining part determining that the specified format in the correspondence information matches the format of the input original material.

According to an aspect of the present invention, a distribution method includes determining, by a computer processor, whether a specified format in correspondence information matches a format of an input original material, the specified format being correlated with a corresponding distribution destination apparatus in the correspondence information; and distributing, by the computer processor, the input original material to the distribution destination apparatus correlated with the specified format in response to determining, by the computer processor, that the specified format in the correspondence information matches the format of the input original material.

According to an aspect of the present invention, a non-transitory computer-readable recording medium has an executable program recorded thereon, wherein the program instructs a computer processor to execute determining whether a specified format in correspondence information matches a format of an input original material, the specified format being correlated with a corresponding distribution destination apparatus in the correspondence information; and distributing the input original material to the distribution destination apparatus correlated with the specified format in response to determining that the specified format in the correspondence information matches the format of the input original material.

The object and advantages of the embodiments will be realized and attained by means of the elements and combinations particularly pointed out in the claims.

It is to be understood that both the foregoing general description and the following detailed description are exemplary and explanatory and not restrictive of the invention as claimed.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a functional configuration of a distribution system according to a first embodiment;

FIG. 2 is a block diagram illustrating a functional configuration of a distribution apparatus according to the first embodiment;

FIG. 3 is a flowchart illustrating a process flow according to the first embodiment (and a second embodiment);

FIG. 4 is a diagram illustrating an input original material according to the first embodiment;

FIG. 5 is a diagram illustrating correspondence information according to the first embodiment;

FIG. 6 is a diagram illustrating a specified format according to the first embodiment;

FIG. 7 is a diagram illustrating a correspondence between specified images and specified coordinates with respect to the specified format according to the first embodiment;

FIG. 8 is a block diagram illustrating a functional configuration of a distribution system according to a third embodiment;

FIG. 9 is a block diagram illustrating a functional configuration of a distribution apparatus according to the third embodiment;

FIG. 10 is a flowchart illustrating a process flow according to the third embodiment (and a fourth embodiment); and

FIG. 11 is a diagram illustrating correspondence information according to the third embodiment; and

FIG. 12 is a block diagram illustrating a hardware configuration of the distribution apparatuses according to the first through fourth embodiments.

### DETAILED DESCRIPTION OF THE PREFERRED EMBODIMENTS

According to the conventional techniques such as those described in Japanese Laid-Open Patent Application No. 2009-146244, a user selects distribution destinations to which an original material is to be distributed, but the user may select a wrong distribution destination so that the original material may be distributed to the wrong distribution destination.

According to an aspect of the present invention, a distribution apparatus is provided that omits the process of selecting a distribution destination of an original material and prevents the original material from being distributed to a wrong distribution destination.

According to an aspect of the present invention, a computer-readable recording medium on which a distribution program is recorded for causing a computer to implement parts of the distribution apparatus is provided.

According to an aspect of the present invention, it is possible to omit the process of selecting a distribution destination of an original material and prevent the original material from being distributed to a wrong distribution destination.

A description is given below, with reference to the accompanying drawings, of embodiments of the present invention. In the following description, elements having the same function are referred to by the same reference numeral, and a repetitive explanation thereof is omitted. Likewise, steps performing the same process are referred to by the same step number, and a repetitive explanation thereof is omitted.

### [a] First Embodiment

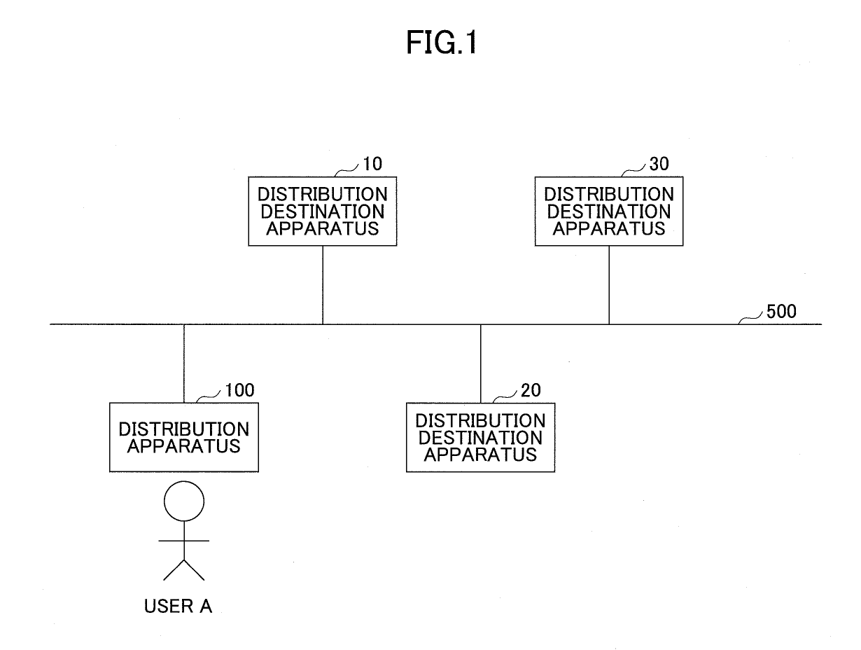

FIG. 1 is a block diagram illustrating a distribution system according to a first embodiment. Referring to FIG. 1, the distribution system includes a distribution apparatus 100, a distribution destination apparatus 10, a distribution apparatus 20, and a distribution apparatus 30, which are interconnected by an electrical network 500 including the Internet and/or a local area network (LAN). A user A inputs an original material to the distribution apparatus 100, and the data of the input original material are distributed to one or more of the distribution destination apparatuses 10, 20, and 30. In the following description, the term “original material” may also mean the electronic data of the original material, or the original material data, input by the user A.

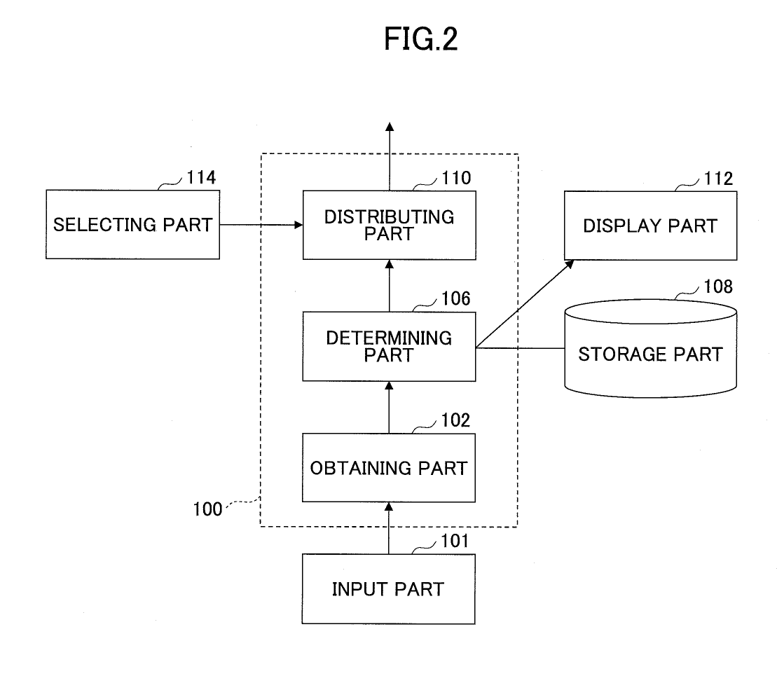

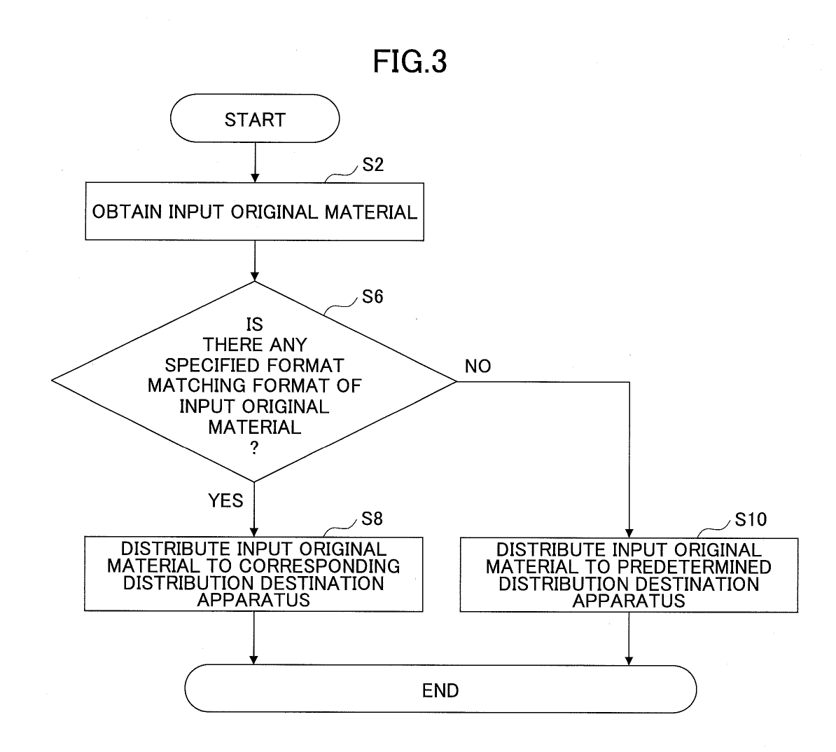

FIG. 2 is a block diagram illustrating a functional configuration of the distribution apparatus 100 according to the first embodiment. FIG. 3 is a flowchart of a process flow of the distribution apparatus 100 according to the first embodiment.

Referring to FIG. 2, the distribution apparatus 100 includes an obtaining part 102, a determining part 106, and a distributing part 110.

Further, an input part 101, a storage part 108, a display part 112, and a selecting part 114, one or more of which may also be included in the distribution apparatus 100, are connected to the distribution apparatus 100.

First, the user A (FIG. 1) inputs an original material, which is an object of distribution, to the distribution apparatus 100 through the input part 101. The original material may be either an electronic medium or a paper medium.

If the original material is a paper medium, the input part 101 may be, for example, an automatic document feeder (ADF), and the user A inputs the original material through the input part 101 (ADF). Then, a scanning part (not graphically illustrated) scans the input original material in the form of a paper medium, so that in step S2, the obtaining part 102 obtains (receives) the scanned original material data (electronic data). The scanning part may be included in the input part 101 or the distribution apparatus 100 (for example, the obtaining part 102). The scanning part may have an optical character recognition (OCR) function.

If the original material to be distributed is electronic data, the user A causes the original material data to be stored in advance in a recording medium (such as a flash memory or an SD card). Then, the user A connects the recording medium to the input part 101, which may be a connector, so that the original material is input to the distribution apparatus 100. In this case, the distribution apparatus 100 may include the input part 101. Then, the obtaining part 102 obtains (receives) the input original material (original material data). The original material to be distributed may also be input to the distribution apparatus 100 using another technique.

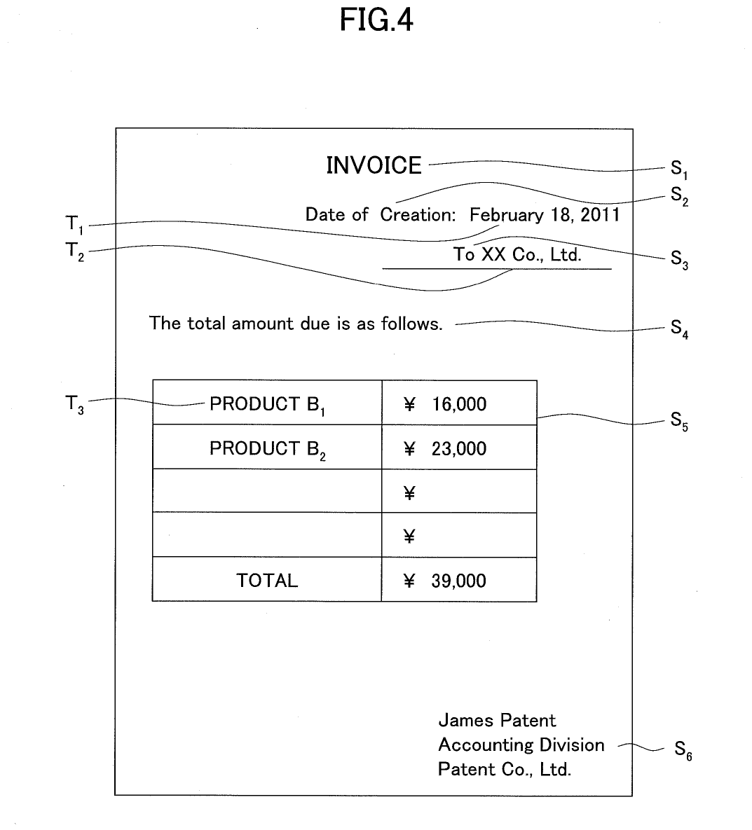

FIG. 4 is a diagram illustrating an example of the original material input by the user A. The input original material in the case of FIG. 4 is an invoice. All the images of the input original material are classified into specified images and unspecified images. The “specified images” refer to images that indicate the format of the input original matter and are present in (for example, drawn or printed on) the original material before the user A inputs (for example, adds or draws) images to the original material. The “unspecified” images refer to images other than the specified images, which are input by the user A. Further, the “images” include letters, characters, figures, patterns, etc.

In the case illustrated in FIG. 4, the specified images of the input original material are a character image S1 of “INVOICE”, a character image S2 of “Date of Creation:” and a comma, an image S3 of a line segment and a character of “To”, a character image S4 of “The total amount due is as follows.”, an image S5 of frame lines, a character of “v”, and a character of “TOTAL”, and a character image S6 of “James Patent Accounting Division Patent Co., Ltd.”.

Further, in the case illustrated in FIG. 4, the unspecified images of the input original material are a character image T1 of “Feb. 18, 2011”, a character image T2 of “XX Co., Ltd.”, and a character image T3 of “Product B1 16,000 Product B2 23,000 39,000”.

Next, in step S6, the determining part 106 determines whether correspondence information (described below) includes a specified format corresponding to the format of the input original material. A detailed description is given of this determining process of step S6.

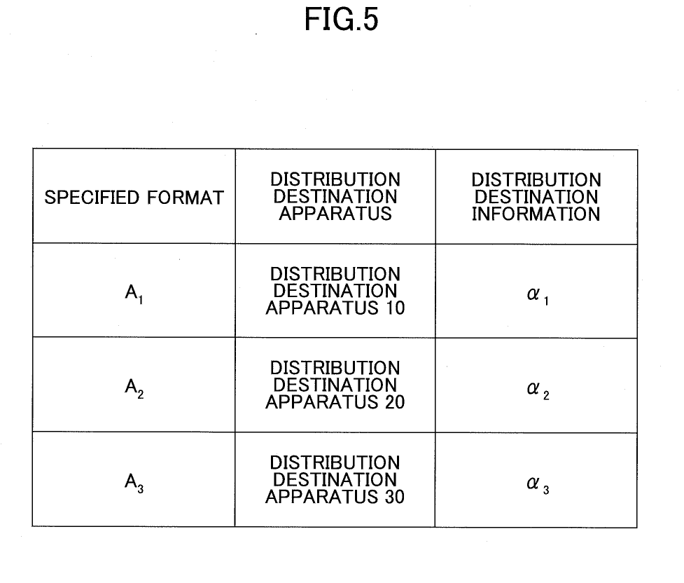

FIG. 5 is a diagram illustrating correspondence information contained in the storage part 108. In the correspondence information illustrated in FIG. 5, each of specified formats A1 through A3 is correlated with a corresponding distribution destination apparatus and its information (indicated as “DISTRIBUTION DESTINATION INFORMATION” in FIG. 5). Here, the distribution destination information may be the address information of the distribution destination apparatus, such as an IP address. In the case illustrated in FIG. 5, the correspondence information includes three items (specified format, distribution destination apparatus, and distribution destination information), but the number of items contained in the correspondence information is not limited to and may be other than three. Further, the number of specified formats in the correspondence information is not limited to three and may be other than three.

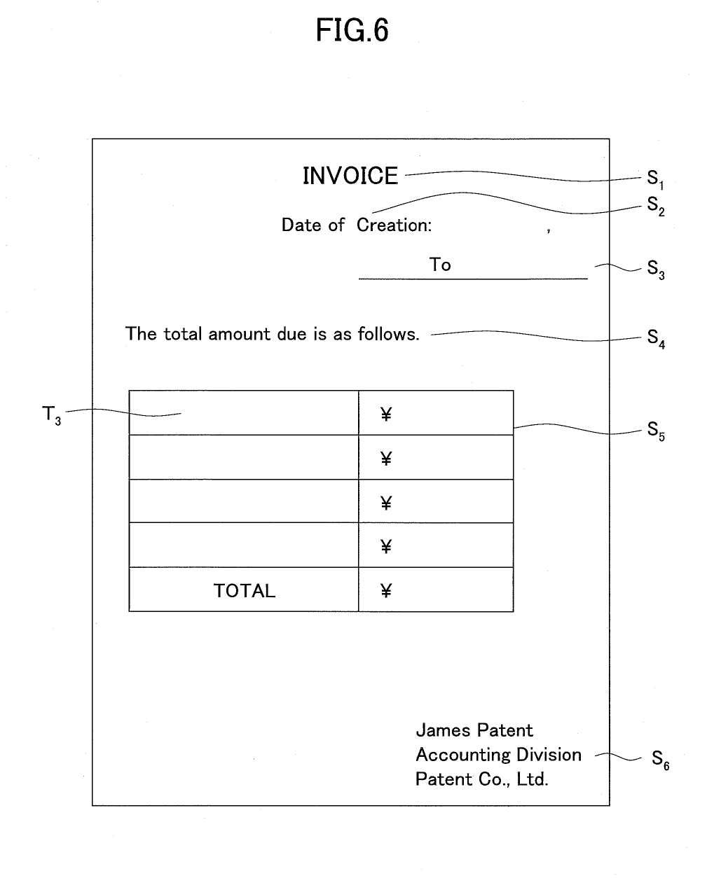

Next, a description is given of the specified format. The “specified format” is a format specified in advance. FIG. 6 illustrates the specified format A1 as an example of the specified format. The specified format includes only specified images and does not include unspecified images. The specified images of the specified format A1 illustrated in FIG. 6 are the character image S1 of “INVOICE”, the character image S2 of “Date of Creation:” and a comma, the image S3 of a line segment and a character of “To”, the character image S4 of “The total amount due is as follows.”, the image S5 of frame lines, a character of “Y”, and a character of “TOTAL”, and the character image S6 of “James Patent Accounting Division Patent Co., Ltd.”. That is, the specified format A1 of FIG. 6 includes six specified images. Further, specified coordinates, at which the six specified images are contained (located), are correlated with the corresponding specified images.

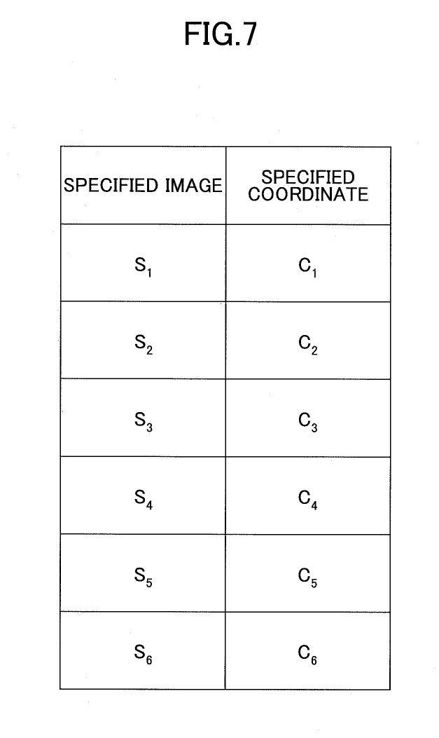

FIG. 7 illustrates correspondence between the specified images S1 through S6 of the specified format A1 and specified coordinates C1 through C6. As described above, the specified format A1 includes the six specified images S1 through S6. FIG. 7 indicates that the six specified images S1 through S6 are located at the coordinates (that is, specified coordinates) C1 through C6, respectively. A specified coordinate C may be a group of the coordinates of pixels composing a single specified image S or the coordinate (x coordinate and y coordinate) widths of the single specified image S. That is, for example, the specified format A1 illustrated in FIG. 6 includes the specified coordinates C1 through C6 of the specified images S1 through S6.

Referring back to step S6 of FIG. 3, the determining part 106 reads specified formats in the correspondence information one by one. In the case illustrated in FIG. 5, the determining part 106 first reads the specified format A1. Then, the determining part 106 determines whether the format of the input original material matches the read specified format A1. A description is given in more detail of this matching determination. The determining part 106 determines whether specified images are located at specified coordinates of the input original material. That is, the determining part 106 determines whether the same images as the specified images of the read specified format are located at the same coordinates as the specified coordinates of the read specified format in the input original material.

It is assumed that FIG. 6 illustrates the specified format A1 read first by the determining part 106. A description is given of the process executed by the determining part 106, taking the image of the input original material illustrated in FIG. 4 and the image of the specified format A1 illustrated in FIG. 6. The determining part 106 reads the first specified format A1 and thereby obtains the specified coordinates C1 through C6 corresponding to the specified images S1 through S6, respectively, of the specified format A1. Then, the determining part 106 determines whether (the same images as) the specified images S1 through S6 are present at (the same coordinates as) the corresponding specified coordinates C1 through C6 of the input original material. That is, the determining part 106 determines whether the input original material contains the specified images S1 through S6 at the same coordinate positions as in the specified format A1. In other words, the determining part 106 determines whether pixels are present at the specified coordinates C1 through C6 of the input original material.

In the case of FIG. 4 and FIG. 6, pixels are present (that is, the specified images are present) at the specified coordinates C1 through C6 of the input original material illustrated in FIG. 4. Therefore, the determining part 106 determines that the format of the input original material matches the specified format A1. That is, the determining part 106 determines that the correspondence information includes a specified format that matches the format of the input original material (YES in step S6).

Further, if the specified format read first by the determining part 106 does not match the format of the input original material, the determining part 106 reads the remaining specified formats one after another from the storage part 108 to determine whether there is a match between the read specified formats and the format of the input original material. Thereby, the determining part 106 determines whether the correspondence information includes a specified format that matches the format of the input original material.

A description is given in the following embodiment of the case where the determining part 106 determines that the correspondence information includes no specified format that matches the format of the input original material (NO in step S6).

If the determining part 106 determines that the correspondence information includes a specified format that matches the format of the input original material (YES in step S6), in step S8, the determining part 106 determines a distribution destination apparatus corresponding to the “specified format that matches the format of the input original material” based on (referring to) the correspondence information stored in the storage part 108, and the distributing part 110 automatically distributes the input original material to the determined distribution destination apparatus via the network 500 (FIG. 1) in response to the affirmative determination in step S6. In the case illustrated in FIG. 5, the format of the input original material matches the specified format A1. Therefore, the distributing part 110 distributes the input original material to the distribution destination apparatus 10 that corresponds to the specified format A1. The distributing part 110 may distribute (address) the input original material to the distribution destination informational of the distribution destination apparatus 10.

In a common original material distributing service, there is a correspondence between the format of an input original material (original material to be distributed) and a distribution destination apparatus (an organization name [for example, a company name] in which the distribution destination apparatus is installed). According to the first embodiment, based on this idea, it is determined whether the correspondence information includes a specified format that matches the format of the input original material. If it is determined that a specified format that matches the format of the input original material is found in the correspondence information, the input original material is delivered to a distribution destination apparatus corresponding to (correlated with) the specified format.

Accordingly, this produces an advantageous effect, namely, omitting the process of causing a user to select a distribution destination of an original material, thereby preventing the user from distributing the original material to a wrong distribution destination.

Further, before the distributing part 110 distributes an input original material to a distribution destination apparatus, the name of the distribution destination apparatus or the name of an organization in which the distribution destination apparatus is installed (for example, “XX Co., Ltd.” in the case of FIG. 4) may be displayed on the display part 112. Causing the name of the distribution destination apparatus or the name of an organization in which the distribution destination apparatus is installed to be displayed on the display part 112 allows the user to recognize or confirm the distribution destination apparatus (before distributing the input original material). This allows the user to distribute the input original material with ease.

### [b] Second Embodiment

Next, a description is given of the second embodiment. The second embodiment is the case of “NO” in step S6 of FIG. 3, that is, the case where the determining part 106 determines that the correspondence information includes no specified format that matches the format of the input original material. In this case, in step S10 of FIG. 3, the distributing part 110 automatically transmits (distributes) the input original material to a predetermined distribution destination apparatus. This allows a user to omit the process of selecting a distribution destination to which the original material is to be distributed.

According to this embodiment, even if the correspondence information includes no specified format that matches the format of the input original material (in the case of “NO” in step S6), a user is allowed to omit the process of selecting a distribution destination of the original material.

Alternatively, however, multiple predetermined distribution destination apparatuses may be preset in, for example, the storage part 108, and in the case of “NO” in step S6, the multiple distribution destination apparatuses may be displayed on the display part 112. Then, a user is caused to select a distribution destination apparatus to which to distribute an input original material from among the displayed distribution destination apparatuses, and the distributing part 110 may distribute the input original material to the selected distribution destination apparatus.

### [c] Third Embodiment

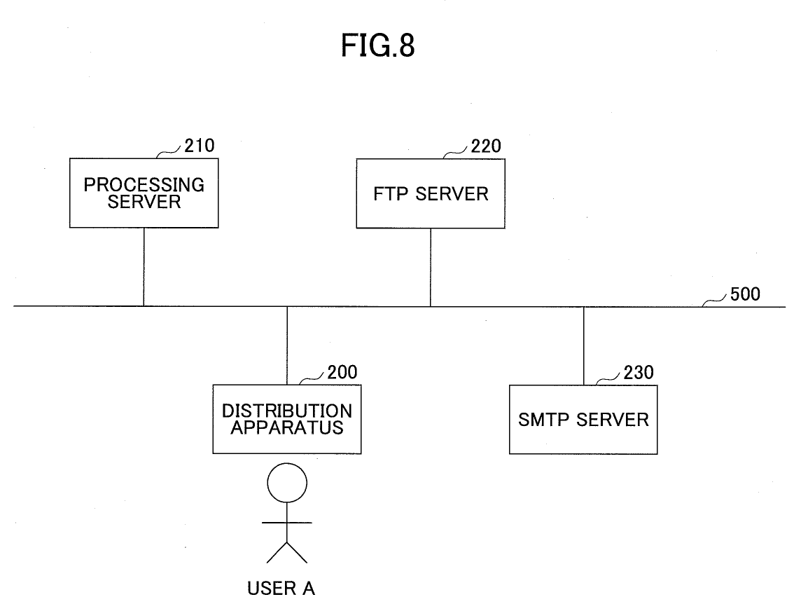

Next, a description is given of a distribution apparatus according to a third embodiment. In the first embodiment, a description is given of the case of causing an input original material to be distributed to a distribution destination apparatus. On the other hand, there is a processing system that subjects an input original material to a process flow selected by a user. FIG. 8 is a block diagram illustrating such a processing system.

Referring to FIG. 8, a processing system according to the second embodiment includes a distribution apparatus 200, a processing server 210, a file transfer protocol (FTP) server 220, and a simple mail transfer protocol (SMTP) server 230, which are interconnected by the network 500.

For example, it is assumed that the processing system illustrated in FIG. 8 has the following two process flows. As a first process flow, in the case where the user A desires to store an original material in the FTP server 220, the following processes (i) through (iv) are executed in order described upon the user A causing the original material to be scanned into the distribution apparatus 200: (i) distributing the original material to the processing server 210 via the network 500, (ii) converting the image format of the original material by the processing server 210, (iii) distributing the original material whose image format has been converted to the FTP server 220 via the network 500, and (iv) storing the distributed original material in the FTP server 220.

Further, as a second process flow, in the case where the user A desires to transmit an original material by e-mail, the following processes (i) through (iv) are executed in order described after inputting a transmission destination address and the original material to the distribution apparatus 200: (i) converting the image format of the input original material by the distribution apparatus 200, (ii) distributing the original material whose image format has been converted to the SMTP server 230, (iii) storing the distributed original material in the SMTP server 230, and (iv) transmitting the stored original material to the transmission destination address. The original material may be scanned into the distribution apparatus 200.

Thus, the user A selects the first process flow or the second process flow in accordance with the process that the user A desires to execute. In a processing system that allows a user to select a process flow as described above, not only the distribution of an original material but also the conversion of the image format of the original material and the storage of the original material in a server are automatically executed, which provides the user with much convenience.

Conventionally, in such a processing system that allows a user to select a process flow, there is a problem in that a process is required that causes the user to select a process flow to be executed on an original material. Further, there is also a problem in that the user may select a wrong process flow and cause the wrong process flow to be executed on the original material.

The third embodiment produces an advantageous effect, namely, omitting the process of selecting a process flow to be executed on an original material and preventing a wrong process flow from being executed on the original material.

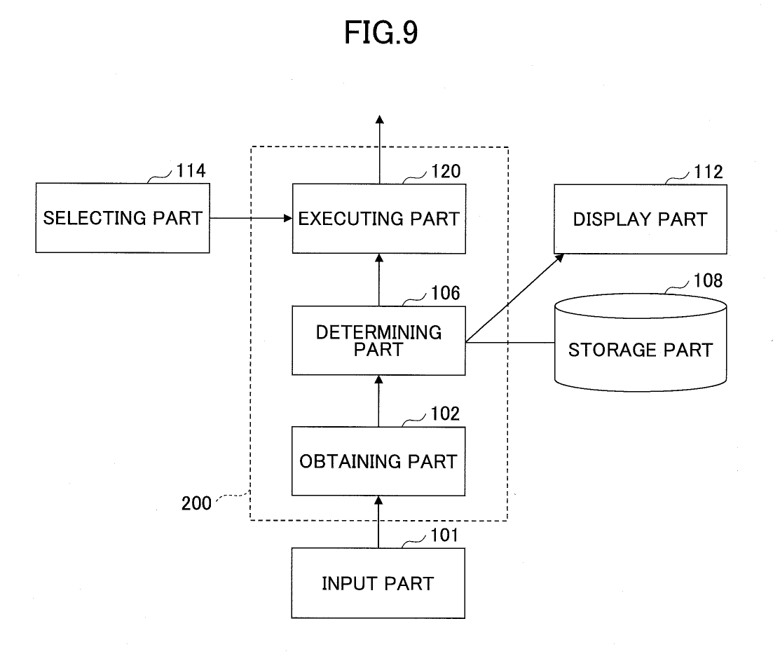

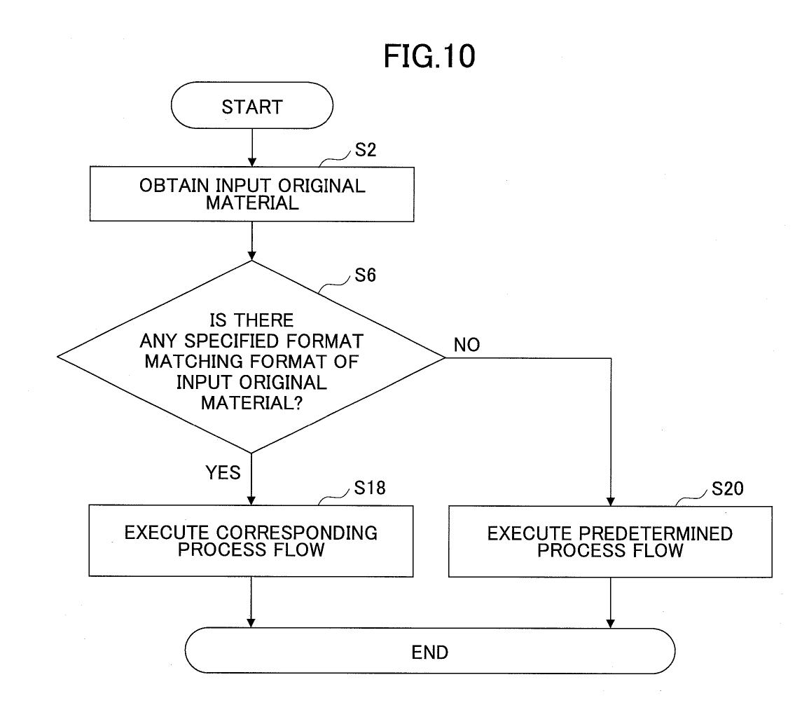

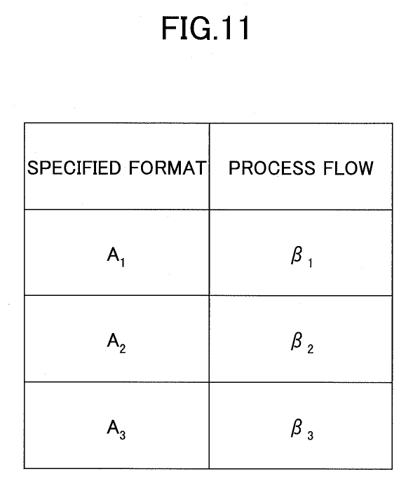

FIG. 9 is a block diagram illustrating a functional configuration of the distribution apparatus 200 according to this embodiment. FIG. 10 is a flowchart illustrating a process flow of the distribution apparatus 200 according to this embodiment. FIG. 11 illustrates correspondence information contained in the storage part 108 according to this embodiment.

The functional configuration illustrated in FIG. 9 is different from the functional configuration illustrated in FIG. 2 in that the distributing part 110 in FIG. 2 is replaced by an executing part 120. Further, the flowchart of FIG. 10 is different from the flowchart of FIG. 3 in that steps S8 and S10 are replaced with steps S18 and S20, respectively. Further, in the correspondence information illustrated in FIG. 11, the specified formats A1 through A3 are correlated with process flows β1 through β3, respectively. For example, the process flow β1 may be the above-described first process flow, and the process flow β2 may be the above-described second process flow.

Referring to FIG. 10, when the processes of steps S2 and S6 end, and it is determined in step S6 that the correspondence information includes a specified format that matches the format of the input original material (YES in step S6), the process flow proceeds to step S18. The determining process of step S6 is the same as that described in the first embodiment, and accordingly, a description thereof is omitted. In step S18, the determining part 106 determines a process flow corresponding to (correlated with) the specified format, determined to match the format of the input original material in step S6, based on (referring to) the correspondence information stored in the storage part 108, and the executing part 120 automatically causes the determined process flow to be executed on the input original material in response to the affirmative determination in step S6.

In a common original material processing service, there is a correspondence between the format of an input original material (original material to be distributed) and a process flow. According to the third embodiment, based on this idea, it is determined whether the correspondence information includes a specified format that matches the format of the input original material. If it is determined that a specified format that matches the format of the input original material is found in the correspondence information, a process flow corresponding to (correlated with) the specified format is executed on the input original material.

Accordingly, this produces an advantageous effect, namely, omitting the process of causing a user to select a process flow for an original material and preventing the user from causing a wrong process flow to be executed on the original material.

Further, before the executing part 120 causing a process flow to be executed on an input original material, the process flow to be executed may be displayed on the display part 112. Causing the process flow to be executed to be displayed on the display part 112 allows the user to recognize or confirm the process flow to be executed (before executing the process flow). This allows the user to cause the process flow to be executed on the input original material with ease.

### [d] Fourth Embodiment

Next, a description is given of a fourth embodiment. The fourth embodiment is the case of “NO” in step S6 of FIG. 10, that is, the case where the determining part 106 determines that the correspondence information includes no specified format that matches the format of the input original material. In this case, in step S20 of FIG. 10, the executing part 120 automatically causes a predetermined process flow to be executed on the input original material. This allows a user to omit the process of selecting a process flow to be executed.

According to this embodiment, even if the correspondence information includes no specified format that matches the format of the input original material (in the case of “NO” in step S6), a user is allowed to omit the process of selecting a process flow for the original material.

Alternatively, however, multiple predetermined process flows may be preset in, for example, the storage part 108, and in the case of “NO” in step S6, the multiple process flows may be displayed on the display part 112. Then, a user is caused to select a process flow to be executed from among the displayed process flows, and the executing part 120 may cause the selected process flow to be executed on the input original material.

### [e] Other Embodiments

In the first embodiment, the storage part 108 is described as containing, as a specified format, the coordinates of the specified images of the specified format. However, specified formats may also be stored in the storage part 108 using other techniques.

Further, the correspondence information contained in the storage part 108 may be subject to addition, modification, and deletion of information by a user.

Further, the distribution apparatuses 100 and 200 of the above-described embodiments may be incorporated into electronic apparatuses such as image forming apparatuses.

Further, when an original material is input to the distribution apparatus 100 and 200 through the input part 101, bibliographic data of the input original material, such as the title and the date and time of input of the input original material, may be added to the input original material. In the case of the distribution apparatus 100, the distributing part 110 may distribute the input original material along with its bibliographic data.

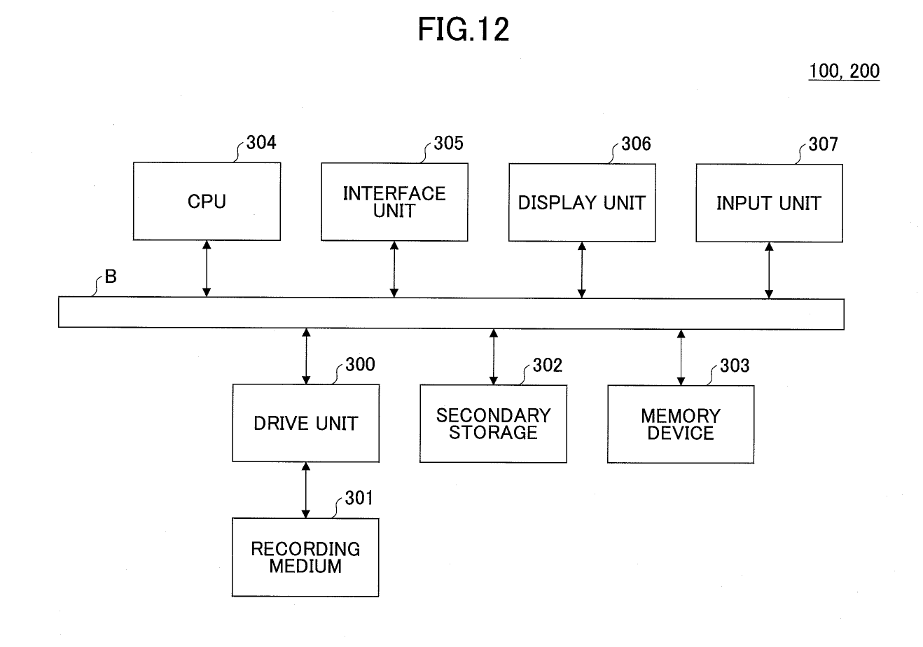

FIG. 12 is a block diagram illustrating a hardware configuration of the distribution apparatuses 100 and 200.

Referring to FIG. 12, the distribution apparatus 100 (200) may include a drive unit 300, a secondary storage 302, a memory device 303, a central processing unit 304, an interface unit 305, a display unit 306, and an input unit 307, which are interconnected by a bus B.

A program (information processing program) causing a computer to execute the processing of the distribution apparatus 100 (200) may be recorded in a non-transitory, computer-readable recording medium 301. Examples of the recording medium 301 include, for example, magnetic recording media, optical disks, magneto-optical recording media, semiconductor memories, and memory cards. Example of magnetic recording media includes flexible disks and magnetic tapes. Examples of optical disks include digital versatile disk (DVD)s, DVD-random access memory (DVD-RAM)s, compact disk read-only memory (CD-ROM)s, CD-recordable (CD-R)s, and CD-rewritable (CD-RW)s. Examples of magneto-optical recording media include magneto-optical disk (MO)s. Examples of semiconductor memories include electronically erasable and programmable read-only memory (EEPROM)s (including flash memories).

This program may be distributed by, for example, selling, giving, or lending a portable recording medium (an example of the recording medium 301) on which the program is recorded. The recording medium 301 on which the program is recorded is loaded into the drive unit 300, which is a mode of implementation of the input part 101 (FIG. 2 and FIG. 9). Then, the program is installed in the secondary storage 302 such as a hard disk drive (HDD) via the drive unit 300. The program may not necessarily be installed through the recording medium 301. For example, the program may be stored and provided in the secondary storage 302. The secondary storage 302 may be an example of the storage part 108 (FIG. 2 and FIG. 9). Alternatively, the program may also be stored in the storage unit of an external server computer, and be downloaded (installed) into the secondary storage 302 from the external server computer via the network 500 (FIG. 1 and FIG. 8). The secondary storage 302 stores the installed program as well as necessary files and data.

In response to an instruction to start the program, the CPU 304 reads the program from the secondary storage 302 and loads the program into the memory device 303 such as a random access memory (RAM). The CPU 304 implements functions related to the distribution apparatus 100 (200) in accordance with the program loaded into the memory device 303. The interface unit 305 is used as an interface for connecting to the network 500. The display unit 306, which may be an example of the display part 112 (FIG. 2 and FIG. 9), displays a graphical user interface (GUI) based on the program. The input unit 307 may include a′keyboard and a mouse and is used to input various operational instructions to the distributing apparatus 100 (200). The input unit 307 may be an operations panel. The drive unit 300, the secondary storage 302, the display unit 306, and the input unit 307 may be provided outside and connected to the distribution apparatus 100 (200).

Further, according to another embodiment, the computer may directly read this program from a portable recording medium on which the program is recorded, and execute processing in accordance with the program. Further, according to yet another embodiment, the program may be transferred from the server computer to this computer instruction by instruction, and every time the computer receives an instruction, the computer may execute processing in accordance with the received instruction. Further, the computer may also execute the above-described processing through an application service provider (ASP)-type service, which implements processing functions by receiving an instruction to execute the program and transmitting the result of the execution of the program. The program according to embodiments of the present invention includes information used for processing by electronic computers and equivalent to a program (such as data that are not direct instructions to computers but have the characteristic of defining computer processing). Further, the distribution apparatus 100 (200) may be implemented by causing a predetermined program to be executed in a computer. However, at least part of the computer processing may be implemented by hardware.

According to an aspect of the present invention, a distribution apparatus may include a determining part configured to determine whether a specified format in correspondence information matches a format of an input original material, the specified format being correlated with a corresponding process flow in the correspondence information; and an executing part configured to cause the process flow correlated with the specified format to be executed on the input original material in response to the determining part determining that the specified format in the correspondence information matches the format of the input original material.

In the distribution apparatus as set forth above, the executing part may be configured to cause a predetermined process flow to be executed on the input original material in response to the determining part determining that no specified format in the correspondence information matches the format of the input original material.

The distribution apparatus as set forth above may further include a storage part configured to contain, as the specified format, a coordinate of a specified image contained in the specified format.

According to an aspect of the present invention, a distribution method may include determining, by a computer processor, whether a specified format in correspondence information matches a format of an input original material, the specified format being correlated with a corresponding process flow in the correspondence information; and causing, by the computer processor, the process flow correlated with the specified format to be executed on the input original material in response to determining, by the computer processor, that the specified format in the correspondence information matches the format of the input original material.

In the distribution method as set forth above, the causing may cause a predetermined process flow to be executed on the input original material in response to determining, by the computer processor, that no specified format in the correspondence information matches the format of the input original material.

In the distribution method as set forth above, a coordinate of a specified image contained in the specified format may be contained in a storage part as the specified format.

According to an aspect of the present invention, a non-transitory computer-readable recording medium may have an executable program recorded thereon, wherein the program instructs a computer processor to execute determining whether a specified format in correspondence information matches a format of an input original material, the specified format being correlated with a corresponding process flow in the correspondence information; and causing the process flow correlated with the specified format to be executed on the input original material in response to determining that the specified format in the correspondence information matches the format of the input original material.

In the non-transitory computer-readable recording medium as set forth above, the causing may cause a predetermined process flow to be executed on the input original material in response to determining that no specified format in the correspondence information matches the format of the input original material.

In the non-transitory computer-readable recording medium as set forth above, a coordinate of a specified image contained in the specified format may be contained in a storage part as the specified format.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. A distribution apparatus, comprising:
a determining part configured to determine whether a specified format in correspondence information matches a format of an input original material, the specified format being correlated with a corresponding distribution destination apparatus in the correspondence information; and
a distributing part configured to distribute the input original material to the distribution destination apparatus correlated with the specified format in response to the determining part determining that the specified format in the correspondence information matches the format of the input original material.

2. The distribution apparatus as claimed in claim 1, wherein the distributing part is configured to distribute the input original material to a predetermined distribution destination apparatus in response to the determining part determining that no specified format in the correspondence information matches the format of the input original material.

3. The distribution apparatus as claimed in claim 1, further comprising:
a storage part configured to contain, as the specified format, a coordinate of a specified image contained in the specified format.

4. A distribution method, comprising:
determining, by a computer processor, whether a specified format in correspondence information matches a format of an input original material, the specified format being correlated with a corresponding distribution destination apparatus in the correspondence information; and
distributing, by the computer processor, the input original material to the distribution destination apparatus correlated with the specified format in response to determining, by the computer processor, that the specified format in the correspondence information matches the format of the input original material.

5. The distribution method as claimed in claim 4, wherein said distributing distributes the input original material to a predetermined distribution destination apparatus in response to determining, by the computer processor, that no specified format in the correspondence information matches the format of the input original material.

6. The distribution method as claimed in claim 4, wherein a coordinate of a specified image contained in the specified format is contained in a storage part as the specified format.

7. A non-transitory computer-readable recording medium having an executable program recorded thereon, wherein the program instructs a computer processor to execute:
determining whether a specified format in correspondence information matches a format of an input original material, the specified format being correlated with a corresponding distribution destination apparatus in the correspondence information; and
distributing the input original material to the distribution destination apparatus correlated with the specified format in response to determining that the specified format in the correspondence information matches the format of the input original material.

8. The non-transitory computer-readable recording medium as claimed in claim 7, wherein said distributing distributes the input original material to a predetermined distribution destination apparatus in response to determining that no specified format in the correspondence information matches the format of the input original material.

9. The non-transitory computer-readable recording medium as claimed in claim 7, wherein a coordinate of a specified image contained in the specified format is contained in a storage part as the specified format.
